(19) United States
(12) Patent Application Publication
(10) Pub. No.: US 2015/0061882 A1
(43) Pub. Date: Mar. 5, 2015

(54) Light Attachment for Metal Detectors

(71) Applicant: Stanley Rivers, Dewey, OK (US)

(72) Inventor: Stanley Rivers, Dewey, OK (US)

(21) Appl. No.: 14/470,270

(22) Filed: Aug. 27, 2014

Related U.S. Application Data
(60) Provisional application No. 61/870,622, filed on Aug. 27, 2013.

(51) Int. Cl. G01V 3/10

(52) U.S. Cl. CPC G01V 3/104
USPC 340/691.8

(57) ABSTRACT

Described is a light attachment for metal detectors that provides users with a visual indication of their proximity to a metal object, which is particularly useful for hearing-impaired individuals. The light attachment includes a control unit comprising a housing having a dimmer switch, a control circuit, and a power source, wherein the housing can be secured to a user's belt by means of a clip thereon. One or more light assemblies are electrically connected to the control unit and the light assemblies each include one or more lights attached to clips that are adapted to be removably affixed to a hat or similar article so that the light is easily viewed by the user. The control unit comprises an input cable such that the light attachment can be operably connected to a conventional metal detector. The lights are adapted to increase in intensity as the user nears a metal object.

### CROSS REFERENCE TO RELATED APPLICATION

This application claims the benefit of U.S. Provisional Application No. 61/870,622 filed on Aug. 27, 2013, entitled “Metal Detector Lighting System.” The above identified patent application is herein incorporated by reference in its entirety to provide continuity of disclosure.

### BACKGROUND OF THE INVENTION

1. Field of the Invention

The present invention relates to metal detector attachments. More specifically, the present invention relates to a light attachment for a metal detector comprising one or more lights that are adapted to illuminate when the metal detector detects a metal object, and the brightness of the lights increases as the user nears a metal object. In this way, the present invention provides visual feedback for the user searching for metal objects.

Metal detectors are portable electronic devices that allow users to detect the presence of nearby metals, and are commonly used to find metals buried underground. People enjoy searching for metals as a hobby, and many metal objects are valuable such as rare coins and jewelry. Hobbyists may use metal detectors to search for metals in various locations, such as at a beach or on the hobbyist's property.

Metal detectors are light-weight, handheld devices that include a sensor disposed on the end of a shaft, and a control box that includes the circuitry and controls for the metal detector. In operation, the user can sweep the sensor over the ground in order to search an area for buried or hidden metals. If the sensor detects a piece of metal, the metal detector produces an audible signal. Generally, the closer the sensor is moved towards the metal, the louder the signal or the more frequent the signal.

Many users may have difficulty hearing the signal produced by the metal detector when the sensor detects a nearby metallic object. This is particularly true for hearing impaired individuals who may instead prefer a visual indication of their proximity to a metal object. Users that do not have a hearing impairment may also find the audible signal to be difficult to hear, particularly when the signal produced by the metal detector is faint or when there is a high degree of background noise, such as from traffic. While some metal detectors include a display thereon, the display may not be easily visible and requires the user's attention to be focused on the display rather than on the area to be searched.

The present invention provides a light attachment for a metal detector that comprises a control unit that can be operably connected to a metal detector by an input adapter. The control unit comprises a dimmer switch, a control circuit, and a power source. One or more light assemblies are electrically connected to the control unit and each light assembly includes one or more lights disposed on a clip such that the user can position the light on a hat or similar object so that the light can be easily seen by the user. The light is adapted to illuminate when the metal detector detects a metal object, and the light increases in brightness as the user approaches the object. In this way, the user is provided with visual feedback when the user is near a piece of metal. The dimmer switch on the control unit allows the user to adjust the brightness of the light depending upon ambient lighting conditions and the time of day the user is searching for metallic objects.

2. Description of the Prior Art

Devices have been disclosed in the prior art that relate to metal detecting devices. These include devices that have been patented and published in patent application publications. These devices generally relate to devices for detecting and identifying metals in a screening area. The following is a list of devices deemed most relevant to the present disclosure, which are herein described for the purposes of highlighting and differentiating the unique aspects of the present invention, and further highlighting the drawbacks existing in the prior art.

One such prior art device is U.S. Patent Application Publication No. 2008/0179522 to Vallon et al. which discloses a hand-held metal detector having a probe that functions as a detector coil and an elongated shaft that serves as a handle. The handle also holds a display and other operating elements thereon. The device further includes at least one radiation detection probe for detecting ionizing radiation. The probes allow a user to locate metallic objects and detect radiation during a single non-contact scan of another person or an object. The display element may contain LED chains or an LCD display that represents the intensity of the radiation. Thus, Vallon et al. fails to describe a light attachment for use with conventional metal detectors, and that includes a light which increases in intensity as a user approaches a metal object.

U.S. Pat. No. 6,541,966 to Keene discloses a metal detecting device comprising a transmitter that generates a magnetic field and a detector for detecting a secondary magnetic field. The device further includes a processor for determining the position or shape of a metal object. Thus, Keene discloses a metal detecting device that allows for accurate location of a metal object and that helps a user to determine the shape of a metal object. Keene does not disclose a metal detector attachment that provides a light that increases in brightness or intensity as the user approaches the metal object.

U.S. Pat. No. 7,414,404 to Keene discloses a metal detecting device having a transmitter for generating a magnetic field and a detector for detecting a secondary magnetic field. This device is particularly related to use in locating metal objects in a human as an aid to surgery. A processing means is provided and helps to determine the depth of the metal object beneath the surface. Thus, Keene is concerned with identifying the location of a metal object within a human body, and does not disclose a device for providing visual rather than audible feedback for a user searching for metal objects.

U.S. Pat. No. 7,545,140 to Humphreys et al. discloses a metal detector having a transmitter that generates a magnetic field, a detector to measure a secondary magnetic field, and a processor. The metal detector is adapted for use in screening individuals for security purposes, and is adapted to derive a magnetic signature that is characteristic of the metal object and that is independent of the orientation and track of the metal object through the surveillance area. Thus, Humphreys et al. discloses a metal detector device for identifying metallic objects in a surveillance area, and fails to disclose a light attachment for a metal detector that provides visual feedback to a user.

Finally, U.S. Pat. No. 5,842,986 to Avrin et al. discloses a method and device for applying a magnetic field to a screening region of a host in order to sense a magnetic field from a magnetic material located within the screening region. Thus, this device can be used to screen patients for metal objects prior to an MRI or similar medical procedure. A computer is used to interpret any detected magnetic fields and can be used to reveal the location and size of a ferromagnetic object within the screening region. Thus, Avrin et al. discloses a metal detecting system for detecting metal objects in a human body, and fails to disclose a light attachment for a conventional metal detector to provide visual feedback to a user when the user is in close proximity to a metal object.

These prior art devices have several known drawbacks. The prior art devices disclose metal detectors adapted for determining the location, shape, or type of metal object detected thereby. Several devices in the prior art are adapted for use as pre-surgery preparation methods to detect metal objects in a human, or are adapted for surveillance and security purposes. Thus, such devices are not concerned with providing a user of the conventional metal detector with visual feedback regarding the user's proximity to a metal object. Further, the prior art devices do not disclose a light that increases in brightness as the user approaches a metal object. The devices disclosed in the prior art relate to improvements to metal detector devices, and do not disclose attachments for conventional or existing metal detector devices. Thus, a user must purchase or use a particular metal detector in order to obtain the claimed benefits and advantages of the prior art devices.

In light of the devices disclosed by the prior art, it is submitted that the present invention substantially diverges in design elements from the prior art and consequently it is clear that there is a need in the art for an improvement to existing metal detector attachment devices. In this regard the instant invention substantially fulfills these needs.

### SUMMARY OF THE INVENTION

In view of the foregoing disadvantages inherent in the known types of metal detectors now present in the prior art, the present invention provides a new metal detector light attachment wherein the same can be utilized for providing convenience for the user when searching for metals using a metal detector.

It is therefore an object of the present invention to provide a new and improved light attachment for metal detectors that has all of the advantages of the prior art and none of the disadvantages.

It is another object of the present invention to provide a light attachment for metal detectors that provides visual feedback to a user when searching for metallic objects.

Another object of the present invention is to provide a light attachment for metal detectors that includes a light that increases in brightness as the user nears a metal object.

Yet another object of the present invention is to provide a metal detector light attachment device that can be positioned adjacent to the user's face so as to be easily visible by the user.

A further object of the present invention is to provide a light attachment for metal detectors that can be used with any type of conventional metal detector.

An additional object of the present invention is to provide a light attachment for metal detectors that includes a dimmer switch in order to adjust the brightness of the light depending upon the ambient lighting conditions.

Another object of the present invention is to provide a light attachment for metal detectors that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the metal detector light attachment of the present invention.

FIG. 2 shows a perspective view of the metal detector light attachment in use.

### DETAILED DESCRIPTION OF THE INVENTION

Reference is made herein to the attached drawings. Like reference numerals are used throughout the drawings to depict like or similar elements of the metal detector light attachment. For the purposes of presenting a brief and clear description of the present invention, the preferred embodiment will be discussed as used for providing visual feedback to a user searching for metal objects using a conventional metal detector. The figures are intended for representative purposes only and should not be considered to be limiting in any respect.

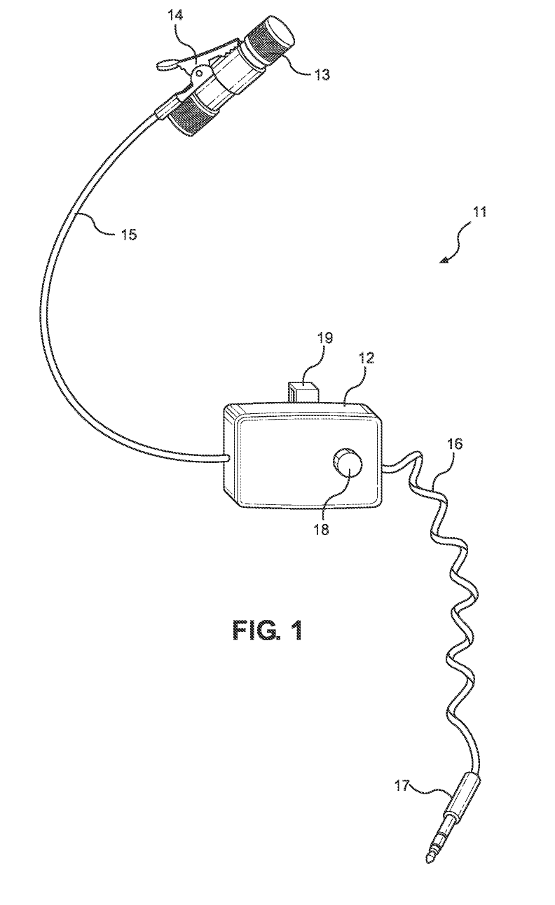

Referring now to FIG. 1, there is shown a perspective view of the metal detector light attachment of the present invention. The metal detector light attachment 11 comprises a control unit 12 that includes a housing that contains a power source, a control circuit, and a dimmer switch 18. The control unit 12 housing is preferably substantially rectangular and includes a front face, a back face, a top wall, a bottom wall, and a pair of sidewalls, defining an interior volume. The back face is adapted to rest against the body of a user. The dimmer switch 18 is preferably positioned on the front face of the housing so that it can be easily accessed by a user. The power source is preferably one or more disposable or rechargeable batteries.

A fastener 19 is secured to the control unit 12 housing and allows for the control unit 12 to be removably secured to a user's belt, or other similar area. In this way, the control unit 12 can be conveniently worn by the user while the user is searching for metals, and the control unit 12 is easily accessed when needed. The fastener 19 can be attached to various portions of the housing including the top wall or the back face of the housing. The fastener 19 preferably comprises a flexible clip, however, various other suitable fasteners can be used, including but not limited to, a strap or loop with hook and loop fastening material thereon.

The present invention further comprises an input cable 16 that is used to electrically connect the control unit 12 to a conventional metal detector. The input cable has a first end secured to the control unit 12 and electrically connected to the control circuit therein, and a second end having an input adapter 17 thereon, wherein the input adapter 17 is adapted to connect to an output port of a conventional metal detector. The input adapter 17 can have various sizes in order to accommodate various models and types of metal detectors. By connecting the input adapter 17 to a metal detector, the metal detector circuit is able to send an electrical signal or detection signal to the control circuit of the present invention.

The present invention further includes an attachment cable 15 having a first end electrically connected to the control circuit, and having at least one second end having a light assembly thereon. Preferably, the attachment cable 15 includes a pair of second ends, such that the present invention includes two light assemblies. Each light assembly includes one or more lights 13 secured to a fastener 14. Preferably, the lights 13 are LED lights, which have a high brightness and low power consumption. The brightness of the LEDs allows the light 13 to be easily seen, even during hours of daylight. The fastener 14 preferably comprises a clip, such as a spring-hinged clip that is biased in a closed configuration. The fastener 14 of each light assembly can be secured to the brim of a user's visor, or the brim of a user's hat such that the light 13 is directed towards the user's eyes. In this way, the light 13 can be easily seen by the user without requiring the user to focus his or her attention on the light or lights 13. The lights 13 can be seen using the user's peripheral vision, allowing the user to focus on searching for metal objects, rather than on the light itself. The attachment cable 15 is of suitable length that the user can position the light assemblies in any of a variety of desired positions on the user's head or hat.

A dimmer switch 18 is positioned on the control unit 12 and serves to allow a user to increase or decrease the brightness of the lights 13 depending on the ambient lighting or on the particular time of day. For example, during the day when it is bright outside, the light 13 may need to have increased brightness in order for the user to easily perceive the light 13 when metal has been detected. In contrast, during low light, the light 13 does not need to be as bright in order for the user to notice the light 13. The dimmer switch 18 determines the maximum brightness of the light 13, and adjusting the dimmer switch 18 does not otherwise interfere with the operation of the light 13. Thus, the light 13 still increases in brightness or intensity as the user nears a metal object regardless of the positioning of the dimmer switch 18.

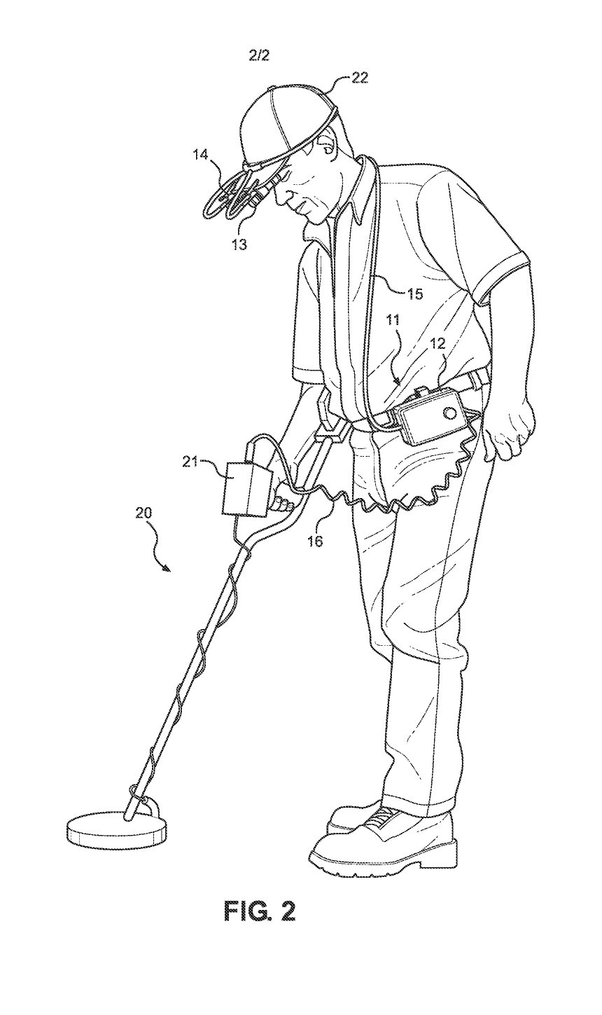

Referring now to FIG. 2, there is shown a view of the metal detector light attachment of the present invention as worn by a user. In operation, the user can connect the input adapter on the input cable 16 of the metal detector light attachment 11 of the present invention into an input jack 21 of a metal detector 20.

The user can then affix the control unit 12 to his or her belt or the waist of his or her pants by means of a fastener, such as a clip, thereon. The attachment cable 15 extends from the control unit 12 and includes one or more light assemblies on a second end thereof. Each light assembly includes one or more LED lights 13 and a fastener 14, such as a spring-hinged clip. The fastener 14 can be secured to the brim of a user's hat 22 or other similar location. The light assemblies are secured to the hat so that the light 13 thereon is directed towards the user's eyes. Further, the attachment cable 15 can be wrapped around the dome shaped portion of a user's hat in order to prevent the attachment cable 15 from dangling in front of the user's head. In some embodiments of the present invention, the attachment cable may include a loop thereon that can be disposed about the dome-shaped portion of a user's hat in order to secure the attachment cable 15 thereon.

Once the metal detector 20 is turned on, the sensor of the metal detector can begin to detect metal objects. When the sensor detects a metal object, the metal detector circuitry determines the strength of the signal and outputs a detection signal. The metal detector circuit can transmit a detection signal to the light attachment 11 of the present invention. The detection signal is sent via the input cable 16 to the control circuit of the present invention within the control unit 12. The control circuit is adapted to correlate the strength of the signal with the brightness of the light 13. Thus, the strength of detection signal and brightness of the light are positively correlated, and as the strength of the signal increases, so does the brightness of the light 13. In this way, the light or lights 13 of the present invention increase in brightness as a user nears a metal object, providing a user with visual feedback of the user's proximity to a metal object. Further, when no metal object is detected, the light or lights 13 are not illuminated.

The present invention provides a metal detector light attachment comprising a control unit that includes a power source, a control circuit, and a dimmer switch. The invention further comprises an input cable that extends from the control unit and that can be electrically connected to an output port on a conventional metal detector. An attachment cable extends from the control unit and includes one or more light assemblies thereon, wherein each light assembly comprises one or more lights and a fastener, such that the lights can be removably positioned adjacent to the user's head, such as on the brim of a visor or hat. The lights are adapted to increase in brightness as the user approaches a metal object in order to provide the user with visual feedback regarding the user's proximity to a metal object.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A metal detector light attachment, comprising:
a control unit comprising a housing having a front face, a back face, a bottom wall, a top wall, and a pair of side walls, defining an interior volume;
wherein said interior volume comprises a control circuit and a power source;
an input cable having a first end electrically connected to said control circuit and a second end having an input adapter adapted to be inserted into an output port on a metal detector;
an attachment cable having a first end electrically connected to said control circuit and at least one second end, wherein each of said at least one second end includes a light assembly thereon;
wherein said light assembly comprises a fastener having a light secured thereto;
wherein said light is adapted to increase in brightness as said metal detector nears a metal object in order to provide visual feedback to the user regarding the user's proximity to a metal object.

2. The metal detector light attachment of claim 1, wherein
said control circuit further comprises a dimmer switch that is adapted to allow a user to adjust the brightness of said light, and
wherein said dimmer switch is disposed on said housing of said control unit.

3. The metal detector light attachment of claim 1, wherein said power source is one or more batteries.

4. The metal detector light attachment of claim 1, wherein said fastener of said light assembly comprises a clip.

5. The metal detector light attachment of claim 1, wherein said fastener of said light assembly comprises a spring-hinged clip.

6. The metal detector light attachment of claim 1, wherein said light comprises one or more LED lights.

7. The metal detector light attachment of claim 1, wherein said housing further comprises a fastener thereon for securement to a user's waistline or belt.
